(19) United States
(12) Patent Application Publication
(10) Pub. No.: US 2019/0094590 A1
(43) Pub. Date: Mar. 28, 2019

(54) LIQUID CRYSTAL DISPLAY DEVICE WITH BUILT-IN TOUCH SENSOR, AND DRIVE METHOD THEREFOR

(71) Applicant: SHARP KABUSHIKI KAISHA, Sakai City, Osaka (JP)

(72) Inventors: ATSUSHI AOKI, Sakai City (JP); DAIJI KITAGAWA, Sakai City (JP); MASAYUKI HATA, Sakai City (JP); YOSHITAKA ORITA, Sakai City (JP)

(73) Assignee: SHARP KABUSHIKI KAISHA, Sakai City, Osaka (JP)

(21) Appl. No.: 16/082,702

(22) PCT Filed: Feb. 28, 2017
(86) PCT No.: PCT/JP2017/007660

§ 371 Date: Sep. 6, 2018

(30) Foreign Application Priority Data
Mar. 7, 2016 (JP) 2016-042964

(51) Int. Cl. G02F 1/1333; G06F 3/044; G02F 1/1335; G06F 3/041; G09G 3/36

(52) U.S. Cl. CPC G02F 1/13338; G06F 3/044; G02F 2001/133612; G06F 3/0412; G09G 3/3611; G02F 1/133602

(57) ABSTRACT

The present invention aims to allow a liquid crystal display device with a built-in touch sensor using a common electrode as an electrode for touch detection to reduce occurrence of flicker when switching from the sleep period to the display period is performed. At least during a part of a sleep period, a display drive portion performs image data write processing in which a voltage is applied to a pixel electrode in a state in which a backlight is maintained in a light-out state by a backlight control portion. For example, the display drive portion applies a voltage corresponding to one of a specific image and a black image to a pixel electrode every predetermined period throughout the sleep period. Further, for example, the display drive portion applies a voltage corresponding to a display image during a period immediately before switching to the display period is performed in the sleep period.

### TECHNICAL FIELD

The present invention relates to a liquid crystal display device with a built-in touch sensor, and a drive method for the same, and in particular relates to a liquid crystal display device with a built-in touch sensor, the device using a common electrode used for displaying image also as an electrode for detecting touching, and a drive method for the same.

### BACKGROUND ART

Conventionally, touch panels have been gaining attention as input devices for operating computer systems. For example, with a touch panel of an electrostatic capacitance type, a position of an object to be detected such as a user's (operator's) finger or a stylus is detected based on variance in electrostatic capacitances. Conventionally, such a touch panel is used placed over a display panel such as a liquid crystal panel. This type of a touch panel provided over a display panel is called as an “out-cell type touch panel” or as “on-cell type touch panel”.

However, an out-cell type (on-cell type) touch panel has problems of an increased weight and thickness of an entire device including a display panel and the touch panel as well as an increased electric power required for driving the touch panel. Thus, in recent years, a panel in which a display panel and a touch panel are integrated as one piece is under development. Such a panel includes a portion that functions as a touch sensor within the panel. Therefore, hereinafter, such a panel is referred to as a “touch sensor built-in display panel”. It should be noted that a touch panel of this touch sensor built-in display panel is called as an “in-cell type touch panel”, for example. According to the touch sensor built-in display panel, it is possible to reduce weight and thickness of an entire device as well as to reduce electric power for driving an entire device.

In the meantime, in recent years, as for display devices, demands for further thinning and further weight reduction are increasing. Also regarding a liquid crystal display device with a built-in touch sensor (a liquid crystal display device having a touch sensor built-in display panel), demands for further thinning and further weight reduction are increasing.

Thus, in order to realize thinning and weight reduction, a liquid crystal display device with a built-in touch sensor in which a common electrode used for image display is also used as an electrode for touch detection has been proposed. The invention related to such a liquid crystal display device with a built-in touch sensor is disclosed in Japanese Laid-Open Patent Publication No. 2014-115647, for example. According to the invention disclosed in Japanese Laid-Open Patent Publication No. 2014-115647, the common electrode is divided into a plurality of electrodes, and presence of a touch at a position corresponding to each of the electrodes of the common electrode is detected during a period in a touch recognition mode.

### PRIOR ART DOCUMENT

### Patent Document

[Patent Document 1] Japanese Laid-Open Patent Publication No. 2014-115647

### SUMMARY OF THE INVENTION

### Problems to be Solved by the Invention

It is common for a liquid crystal display device, in order to reduce power consumption, to stop image display if the device is not operated for a certain period until the device is operated next time. During a sleep period during which an image is not displayed, a backlight is turned to a light-out state and image data write processing (a process for applying voltages depending on a display image to pixel electrodes) is stopped. As a result, power consumption may be significantly reduced as compared to a case in which a sleep period is not provided. In the meantime, in a case in which a liquid crystal display device with a built-in touch sensor in which a common electrode is used as an electrode for touch detection employs a drive method where a sleep period is provided, the device is driven as illustrated in FIG. 16. It should be noted that, hereinafter, for convenience sake, a portion related to a display operation in the liquid crystal panel is referred to as a “main body of the liquid crystal panel”. As illustrated in FIG. 16, during a display period, display operation (image data write processing) is performed on the main body of the liquid crystal panel in a state in which backlight is lit up. In the sleep period, the backlight is maintained in the light-out state, and display operation is not performed in the main body of the liquid crystal panel. While a touch sensor is driven both in the display period and the sleep period, a drive frequency for touch detection is typically set to be lower in the sleep period than in the display period. In such a liquid crystal display device with a built-in touch sensor, flicker may occur when switching from the sleep period to the display period is performed. The reason why this occurs will be described below.

In the liquid crystal display device, transmittance in each pixel depends on a voltage between a pixel electrode and a common electrode. In order to control the transmittance, in the display period, a desired voltage (a voltage depending on a display image) is applied to a pixel electrode in each pixel for each vertical scanning period. On the other hand, in the sleep period, the pixel electrode is maintained in a floating state, and a voltage is not applied to the pixel electrode. In the sleep period, under such a condition, only the common electrode is driven in order to perform touch detection. With this, an electric charge due to driving of the common electrode is accumulated within the liquid crystal panel, and a magnitude of the voltage between the pixel electrode and the common electrode varies from an original magnitude of the voltage (typically, the voltage at a time point when switching from the display period to the sleep period is performed). As a result, flicker becomes visible when switching from the sleep period to the display period is performed (when the backlight is lit up).

Thus, an object of the present invention is to allow a liquid crystal display device with a built-in touch sensor using a common electrode as an electrode for touch detection to reduce occurrence of flicker when switching from the sleep period to the display period is performed.

### Means for Solving the Problems

A first aspect of the present invention is directed to a liquid crystal display device with a built-in touch sensor, the liquid crystal display device having a display period for performing image display and a sleep period for stopping image display, the liquid crystal display device including:

a liquid crystal panel including a pixel electrode and a common electrode;

a backlight configured to irradiate the liquid crystal panel with light;

a display drive portion configured to perform image data write processing during the display period, the image data write processing being a process in which a desired voltage is applied to the pixel electrode in a state in which a constant voltage is applied to the common electrode;

a backlight control portion configured to maintain the backlight in a light-up state during the display period, and maintain the backlight in a light-out state during the sleep period; and

a sensor drive portion configured to perform position detection processing during both of the display period and the sleep period, the position detection processing being a process in which a position on the liquid crystal panel that has been touched is detected,

wherein

the common electrode is used as an electrode for the position detection processing, and

the display drive portion also performs the image data write processing at least during a part of the sleep period.

According to a second aspect of the present invention, in the first aspect of the present invention,

the display drive portion performs the image data write processing every predetermined period throughout the sleep period.

According to a third aspect of the present invention, in the second aspect of the present invention,

a voltage applied to the pixel electrode in the image data write processing during the sleep period is a voltage corresponding to a specific image.

According to a fourth aspect of the present invention, in the third aspect of the present invention,

the specific image is an image for displaying an entire screen of the liquid crystal panel in black.

According to a fifth aspect of the present invention, in the first aspect of the present invention,

the display drive portion performs the image data write processing during a period immediately before switching to the display period is performed in the sleep period.

According to a sixth aspect of the present invention, in the fifth aspect of the present invention,

a voltage applied to the pixel electrode in the image data write processing during the sleep period is a voltage corresponding to an image to be displayed in the display period.

According to a seventh aspect of the present invention, in the first aspect of the present invention,

the sensor drive portion performs the position detection processing less frequently in the sleep period than in the display period.

An eighth aspect of the present invention is directed to a drive method for a liquid crystal display device with a built-in touch sensor, the liquid crystal display device having a display period for performing image display and a sleep period for stopping image display, wherein

the liquid crystal display device includes:
a liquid crystal panel including a pixel electrode and a common electrode;
a backlight configured to irradiate the liquid crystal panel with light;
a display drive portion configured to perform image data write processing in which a desired voltage is applied to the pixel electrode in a state in which a constant voltage is applied to the common electrode;
a backlight control portion configured to control a state of the backlight; and
a sensor drive portion configured to perform position detection processing during both of the display period and the sleep period, the position detection processing being a process in which a position on the liquid crystal panel that has been touched is detected,

the common electrode is used as an electrode for the position detection processing, and

the drive method includes:
a display step in which, during the display period, the backlight control portion maintains the backlight in a light-up state and the display drive portion performs the image data write processing so that a voltage depending on a target display image is applied to the pixel electrode;
a stopping step in which the backlight control portion maintains the backlight in a light-out state during the sleep period; and
an image data write insertion step in which the display drive portion performs the image data write processing at least during a part of the sleep period.

### Effects of the Invention

According to the first aspect of the present invention, in the liquid crystal display device with a built-in touch sensor in which the common electrode is used as an electrode for position detection processing, image data write processing is performed while the backlight is maintained in the light-out state during a part of the sleep period for stopping image display. Therefore, by the image data write processing, an electric charge accumulated within the liquid crystal panel due to a drive signal for position detection processing is discharged. With this, it is possible to reduce occurrence of flicker when switching from the sleep period to the display period is performed (when the backlight is lit up).

According to the second aspect of the present invention, during the sleep period, an electric charge accumulated within the liquid crystal panel due to a drive signal for position detection processing is discharged every predetermined period. With this, it is possible to effectively reduce occurrence of flicker when switching from the sleep period to the display period is performed (when the backlight is lit up).

According to the third aspect of the present invention, it is possible to obtain the same effect as in the second aspect of the present invention.

According to the fourth aspect of the present invention, in the image data write processing during the sleep period, the image for displaying an entire screen of the liquid crystal panel in black is inserted. Therefore, it is possible to obtain an effect that an image inserted during the sleep period does not become easily visible to the user, even if the device is a reflective type liquid crystal display device or a semi-transmissive type liquid crystal display device.

According to the fifth aspect of the present invention, immediately before switching from the sleep period to the display period is performed, image data write processing is performed while the backlight is maintained in the light-out state. With this, similarly to the first aspect of the present invention, it is possible to reduce occurrence of flicker when switching from the sleep period to the display period is performed (when the backlight is lit up). Further, image data write processing is performed in the sleep period only immediately before switching to the display period is performed.

Therefore, an increase in power consumption due to image data write processing being performed during the sleep period may be suppressed.

According to the sixth aspect of the present invention, it is possible to reduce occurrence of flicker more effectively.

According to the seventh aspect of the present invention, position detection processing is less performed in the sleep period than in the display period. Therefore, accumulation of an electric charge within the liquid crystal panel during the sleep period may be suppressed. With this, it is possible to reduce occurrence of flicker effectively.

According to the eighth aspect of the present invention, it is possible to provide the same effect as in the first aspect of the present invention for the drive method for the liquid crystal display device with a built-in touch sensor.

### BRIEF DESCRIPTION OF THE DRAWINGS

FIG. 1 is a diagram for illustration of a drive method for a liquid crystal display device according to a first embodiment of the present invention.

FIG. 2 is a block diagram illustrating a general configuration of the liquid crystal display device according to the first embodiment.

FIG. 3 is a circuit diagram illustrating a configuration of a pixel formation portion in the first embodiment.

FIG. 4 is a block diagram illustrating a configuration for image display in the first embodiment.

FIG. 5 is a schematic plan view illustrating a general configuration for touch detection in the first embodiment.

FIG. 6 is a diagram for illustration of a slit provided for a common electrode in the first embodiment.

FIG. 7 is a schematic plan view enlarging a part of FIG. 5.

FIG. 8 is a partial sectional view of the liquid crystal panel in the first embodiment.

FIG. 9 is a diagram for illustration of generation of a lateral electric field in image display in the first embodiment.

FIG. 10 is a block diagram illustrating a detailed functional configuration of a sensor drive portion in the first embodiment.

FIG. 11 is a waveform chart illustrating a variance in a voltage of a common electrode during a display period in the first embodiment.

FIG. 12 is a waveform chart illustrating a variance in the voltage of the common electrode during a sleep period in the first embodiment.

FIG. 13 is a diagram for illustration of effects in the first embodiment.

FIG. 14 is a diagram for illustration of a drive method for the liquid crystal display device according to a modified example of the first embodiment.

FIG. 15 is a diagram for illustration of a drive method for the liquid crystal display device according to a second embodiment of the present invention.

FIG. 16 is a diagram for illustration of the conventional drive method for the liquid crystal display device.

### MODES FOR CARRYING OUT THE INVENTION

Hereinafter, embodiments of the present invention will be described with reference to the accompanying drawings.

### 1. First Embodiment

A liquid crystal display device according to a first embodiment of the present invention will be described. The liquid crystal display device according to this embodiment is a liquid crystal display device with a built-in touch sensor.

Specifically, a touch sensor is built within a liquid crystal panel. Further, in the liquid crystal display device according to this embodiment, image display is stopped if the device is not operated for a certain period until the device is operated next time. Specifically, a display period in which image display is performed and a sleep period in which image display is not performed are provided. As a method of touch detection, a self-capacitance method of an electrostatic capacitance type is employed. An IPS mode is employed as an operational mode for liquid crystal. The above also applies to a liquid crystal display device according to a second embodiment.

### 1.1 Overall Structure and Outline of Operation

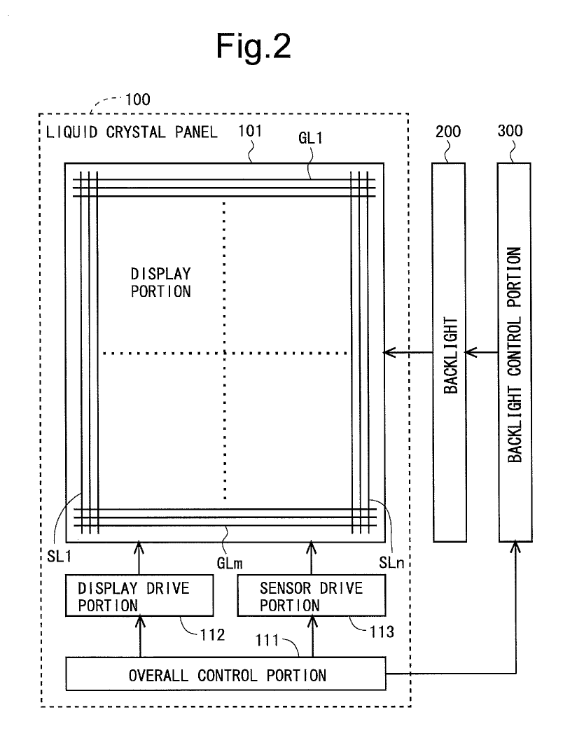

FIG. 2 is a block diagram illustrating a general configuration of the liquid crystal display device according to this embodiment. The liquid crystal display device includes a liquid crystal panel 100, a backlight 200, and a backlight control portion 300. The liquid crystal panel 100 includes a display portion 101, an overall control portion 111, a display drive portion 112, and a sensor drive portion 113. More specifically, ICs (integrated circuits) functioning as the overall control portion 111, the display drive portion 112, and the sensor drive portion 113 are mounted on a partial region over a glass substrate that constitutes the liquid crystal panel 100, and a major part of the liquid crystal panel 100 constitutes the display portion 101.

The display portion 101 is provided with a plurality of (n) source bus lines (video signal lines) SL1-SLn, and a plurality of (m) gate bus lines (scanning signal lines) GL1-GLm. Pixel formation portions (not shown in FIG. 2) each forming a pixel are provided so as to correspond to respective intersections between the plurality of source bus lines SL1-SLn and the plurality of gate bus lines GL1-GLm. Further, the display portion 101 is provided with a plurality of common electrode wirings (not shown in FIG. 2) which are metallic wirings.

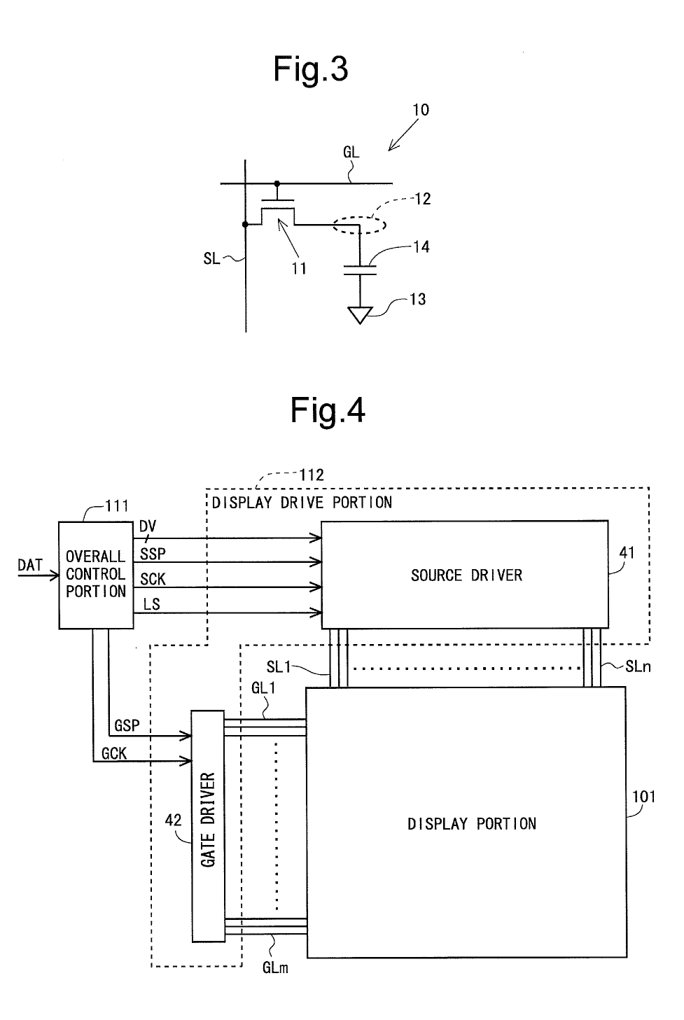

FIG. 3 is a circuit diagram illustrating a configuration of one of pixel formation portions 10. Each of the pixel formation portions 10 includes: a TFT (thin-film transistor) 11, which is a switching element, having a gate electrode connected to the gate bus line GL that passes a corresponding intersection and a source electrode connected to the source bus line SL that passes the same intersection; a pixel electrode 12 connected to a drain electrode of the TFT 11; a common electrode 13 to which a constant voltage is applied during the display period; and a liquid crystal capacitance 14 constituted by the pixel electrode 12 and the common electrode 13. It should be noted that there is a case in which an auxiliary capacitance is provided in parallel with the liquid crystal capacitance 14.

As the TFT 11 within the pixel formation portion 10, typically, an oxide TFT (a thin-film transistor having an oxide semiconductor layer) is employed. The oxide semiconductor layer contains, for example, In—Ga—Zn—O semiconductor (e.g., indium gallium zinc oxide). In—Ga—Zn—O semiconductor is a ternary oxide of In, Ga, and Zn. A TFT having an In—Ga—Zn—O semiconductor layer has high mobility (mobility exceeding 20 times compared to a-SiTFT) and a low leak current (a leak current less than one hundredth compared to a-SiTFT). It should be noted that a TFT other than the oxide TFT may be used as the TFT 11 within the pixel formation portion 10.

Next, operations of components illustrated in FIG. 2 will be described. The overall control portion 111 controls operations of the display drive portion 112, the sensor drive portion 113, and the backlight control portion 300. The display drive portion 112 performs image data write processing (processing for applying a voltage depending on a display image to the pixel electrode 12) based on the control by the overall control portion 111, so that a desired image is displayed in the display portion 101. This image data write processing is performed by applying, in a state in which a constant voltage is applied to the common electrode 13, a video signal depending on a display image to the source bus lines SL1-SLn while the gate bus lines GL1-GLm are sequentially driven one by one. The sensor drive portion 113 performs touch detection (position detection processing in which a position on the liquid crystal panel 100 that has been touched is detected), based on the control by the overall control portion 111. The touch detection will be described later in detail. The backlight control portion 300 controls a state (light-up state/light-out state) of the backlight 200 based on the control by the overall control portion 111. Specifically, the backlight control portion 300 maintains the backlight 200 in a light-up state during the display period, and maintains the backlight 200 in a light-out state during the sleep period. The backlight 200 irradiates a back surface of the liquid crystal panel 100 with light.

### 1.2 Configuration for Image Display

FIG. 4 is a block diagram illustrating a configuration for image display. This liquid crystal display device is provided with the display portion 101, the overall control portion 111, and the display drive portion 112, as components for image display. The display drive portion 112 is configured by a source driver 41 and a gate driver 42.

The overall control portion 111 receives an image signal DAT sent from outside, and outputs a digital video signal DV, as well as a source start pulse signal SSP, a source clock signal SCK, a latch strobe signal LS, a gate start pulse signal GSP, and a gate clock signal GCK which are for controlling image display in the display portion 101.

The source driver 41 receives the digital video signal DV, the source start pulse signal SSP, the source clock signal SCK, and the latch strobe signal LS sent from the overall control portion 111, and applies a driving video signal to each of the source bus lines SL. At this time, at timing at which a pulse of the source clock signal SCK is generated, the digital video signal DV indicating a voltage to be applied to each of the source bus lines SL is sequentially held in the source driver 41. Then, at timing at which a pulse of the latch strobe signal LS is generated, the digital video signals DV that has been held are converted into analog voltages. The converted analog voltages are applied at the same time to the source bus lines SL1-SLn as driving video signals.

The gate driver 42 repeats applying an active scanning signal to each of the gate bus lines GL1-GLm with a cycle of one vertical scanning period, based on the gate start pulse signal GSP and the gate clock signal GCK which are outputted from the overall control portion 111.

By applying the driving video signals to the source bus lines SL1-SLn and applying the scanning signals to the gate bus lines GL1-GLm as described above, an image based on the image signal DAT sent from outside is displayed on the display portion 101.

### 1.3 Configuration for Touch Detection

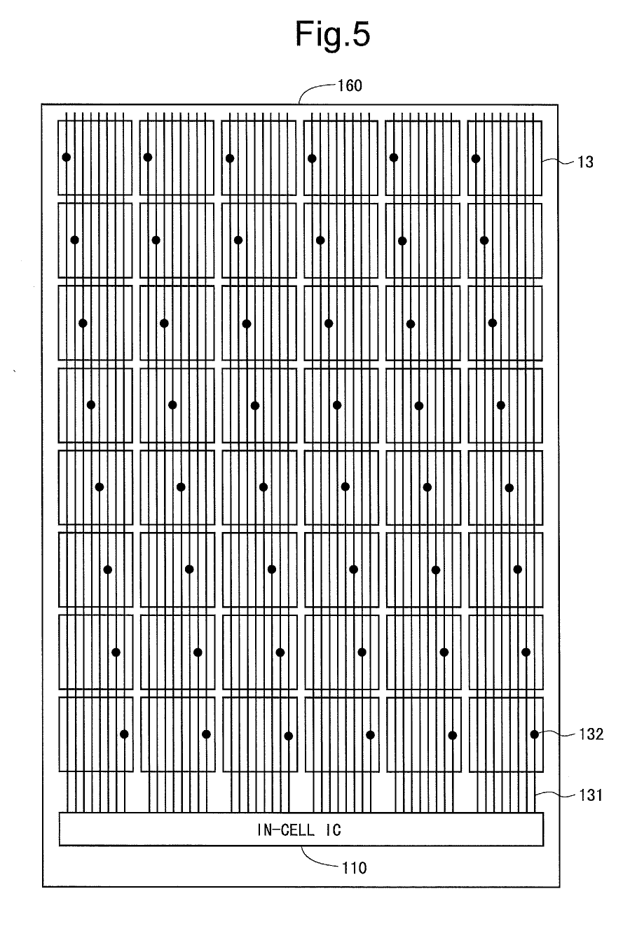

Next, a configuration for touch detection will be described with reference to FIG. 5 to FIG. 10. FIG. 5 is a schematic plan view illustrating a general configuration for touch detection. The liquid crystal panel 100 is configured by a TFT array substrate and a color filter substrate that are two glass substrates facing one another. Components for touch detection are provided on the TFT array substrate 160 which is one of the two glass substrates. As illustrated in FIG. 5, on the TFT array substrate 160, common electrodes 13, common electrode wirings 131, and an in-cell IC 110 are provided as the components for touch detection. Further, on the TFT array substrate 160, contact portions 132 for connecting the common electrodes 13 and the common electrode wirings 131 are provided. The in-cell IC 110 includes the sensor drive portion 113 described above (see FIG. 2). It should be noted that, in this embodiment, the overall control portion 111 and the display drive portion 112 are also included in the in-cell IC 110.

The common electrodes 13 are realized by transparent conducting layers such as ITO (Indium Tin Oxide) or the like.

Further, 48 divided common electrodes 13 are provided in a tiled manner, as illustrated in FIG. 5. More specifically, six common electrodes 13 are provided separately in a lateral direction (a direction in which the gate bus lines GL extend), and eight common electrodes 13 are provided separately in a longitudinal direction (a direction in which the source bus lines SL extend). In this embodiment, the common electrodes 13 divided in this manner are used as the electrodes for touch detection. Here, the example in which the 48 divided common electrodes 13 are provided, the number of divisions is not particularly limited.

Any number of the divided common electrodes 13 may be provided depending on a target resolution.

On the TFT array substrate 160, 48 common electrode wirings 131 are provided in order to control voltages of the 48 common electrodes 13. The 48 common electrodes 13 and the 48 common electrode wirings 131 correspond to each other one on one and each of the common electrodes 13 is connected to corresponding one of the common electrode wirings 131 at the contact portion 132. Further, the 48 common electrode wirings 131 are connected to the in-cell IC 110. With such a configuration, a voltage of each of the common electrodes 13 may be controlled by the in-cell IC 110.

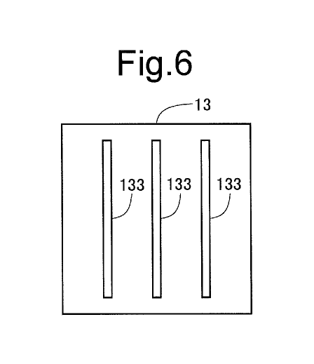

It should be noted that, in this embodiment, an IPS mode is employed as an operational mode for liquid crystals. Therefore, for example, slits 133 are provided for each of the common electrodes 13 as illustrated in FIG. 6, so that a lateral electric field may be produced in a liquid crystal layer.

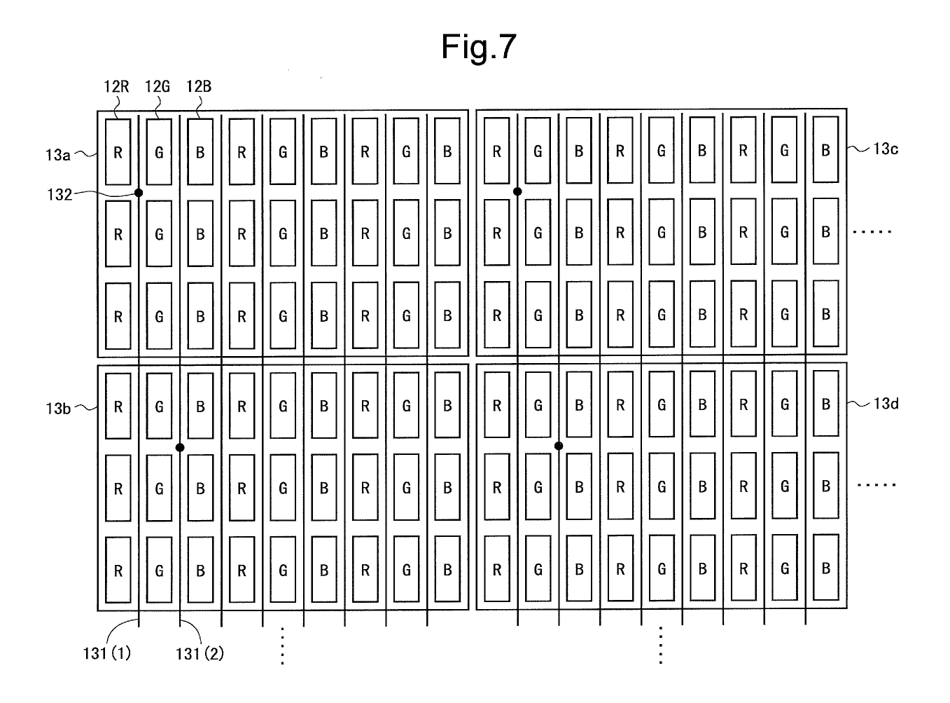

FIG. 7 is a schematic plan view enlarging a part of FIG. 5. FIG. 7 shows a part at which four common electrodes 13a, 13b, 13c, and 13d out of the 48 common electrodes 13 are positioned. As illustrated in FIG. 7, each of the common electrodes 13 corresponds to the plurality of pixel electrodes 12. Specifically, one common electrode 13 corresponds to a plurality of pixels. It should be noted that, on the TFT array substrate 160, the common electrode 13 is positioned above the pixel electrodes 12. Further, in FIG. 7, a pixel electrode for displaying red (a pixel electrode provided at a position facing a red color filter) is indicated by a reference number 12R, a pixel electrode for displaying green (a pixel electrode provided at a position facing a green color filter) is indicated by a reference number 12G, and a pixel electrode for displaying blue (a pixel electrode provided at a position facing a blue color filter) is indicated by a reference number 12B.

The common electrode wirings 131 are arranged so as not to overlap with the pixel electrode 12 in the vertical direction.

Each of the common electrodes 13 is connected to one of the common electrode wirings 131 via the contact portion 132. For example, the common electrode 13a is connected to a common electrode wiring 131(1), and the common electrode 13b is connected to a common electrode wiring 131(2). To each of the common electrodes 13, a voltage (a common voltage V1 or a sensor voltage V2 that will be later described) is applied via the corresponding common electrode wiring 131.

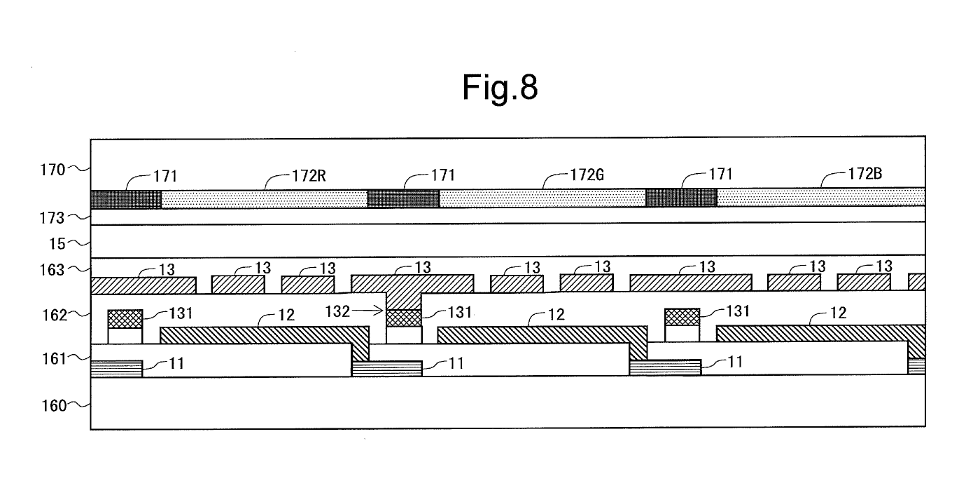

FIG. 8 is a partial sectional view of the liquid crystal panel 100. As described above, the liquid crystal panel 100 is configured by the TFT array substrate 160 and the color filter substrate 170 that are two glass substrates that face one another.

On the TFT array substrate 160, the TFTs 11 are formed, and the pixel electrodes 12 are formed so as to be connected to respective drain electrodes of the TFTs 11. An insulating layer 161 is formed between the TFT array substrate 160 and the pixel electrode 12. An insulating layer 162 is formed over the pixel electrode 12, and the common electrodes 13 are formed above the insulating layer 162. Further, the common electrode wirings 131 are formed beneath the common electrodes 13, and the common electrodes 13 are connected to the respective common electrode wirings 131 at the corresponding contact portions 132. Moreover, over the common electrode 13, a polyimide alignment film 163 is formed.

Over the color filter substrate 170, color filters of three colors (a red color filter 172R, a green color filter 172G, and a blue color filter 172B) are formed. Further, a black matrix 171 is formed between the adjacent color filters in order to prevent a leakage of light through a gap between the adjacent pixels. It should be noted that the common electrode wirings 131 are positioned behind the black matrix 171 so as not to become visible. Above the black matrix 171 and the color filters 172R, 172G, and 172B (on the lower side in FIG. 8), a polyimide alignment film 173 is formed.

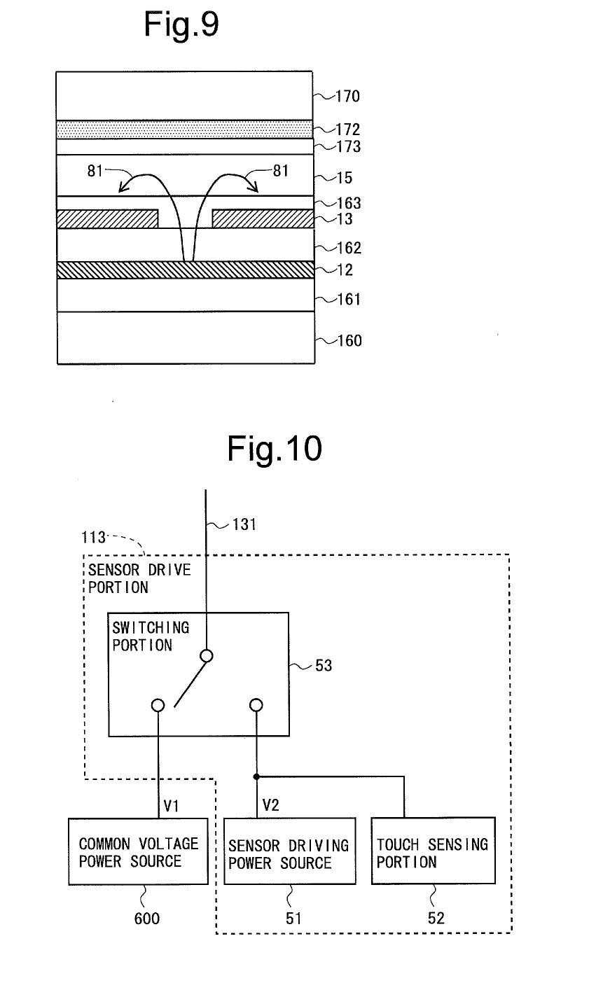

Further, between the polyimide alignment film 163 on the side of the TFT array substrate 160 and the polyimide alignment film 173 on the side of the color filter substrate 170, a liquid crystal layer 15 is provided. By the configuration as described above, when image display is performed, a lateral electric field is produced as indicated by an arrow 81 in FIG. 9.

FIG. 10 is a block diagram illustrating a detailed functional configuration of the sensor drive portion 113. As illustrated in FIG. 10, the sensor drive portion 113 includes a sensor driving power source 51, a touch sensing portion 52, and a switching portion 53. Further, the sensor drive portion 113 is connected to the common electrode wiring 131 and a common voltage power source 600. The common voltage power source 600 outputs a voltage (hereinafter referred to as a “common voltage”) V1 to be applied to the common electrodes 13 during the display period. The sensor driving power source 51 outputs a voltage (hereinafter referred to as a “sensor voltage”) V2 to be applied to the common electrodes 13 at predetermined intervals when touch detection is performed. The touch sensing portion 52 detects whether or not touching to the position of the corresponding common electrode 13 is present. The switching portion 53 switches the connection destination of the common electrode wiring 131 between the sensor driving power source 51 and the common voltage power source 600.

In the configuration as described above, when touch detection is performed, the connection destination of the common electrode wiring 131 is switched by the switching portion 53 every predetermined period between the sensor driving power source 51 and the common voltage power source 600. With this, a drive signal for touch detection (a signal in which the common voltage V1 and the sensor voltage V2 repeat alternately) is supplied to the common electrode 13. The touch sensor is driven in this manner. In the meantime, depending on whether touch is present or not, a value of capacitance at a position of the common electrode 13 varies. Therefore, the touch sensing portion 52 is able to detect whether or not touch is present by measuring a voltage or a current at a predetermined position, for example.

The sensor drive portion 113 as described above is provided for each of the common electrode wirings 131.

Therefore, the 48 common electrode wirings 131 are independently driven. Specifically, the 48 common electrodes 13 are independently driven. With this, it is possible to detect a position on the liquid crystal panel 100 that has been touched.

### 1.4 Drive Method

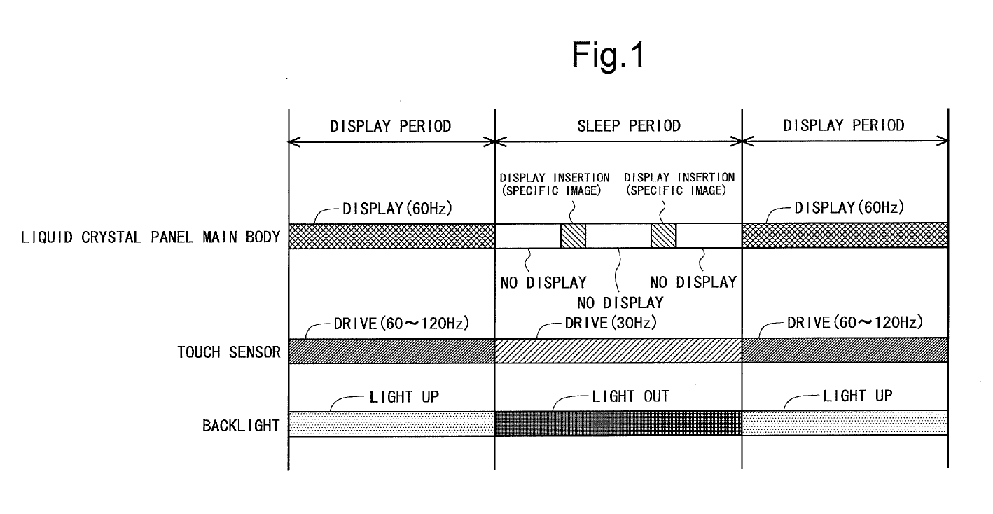

FIG. 1 is a diagram for illustration of a drive method for the liquid crystal display device according to this embodiment. During the display period, the backlight 200 is maintained in the light-upstate, and a display operation (image data write processing) is performed in the main body of the liquid crystal panel 100. A drive frequency of the display operation is 60 Hz, for example. Further, during the display period, the touch sensor is driven at a drive frequency from 60 Hz to 120 Hz, for example. In this manner, the drive frequency of the touch sensor is set to be higher than the drive frequency of the display operation. This is because, if the drive frequency of the touch sensor is set to be lower than the drive frequency of the display operation, timing for touch detection becomes later than timing for refreshing display, resulting in poor operational feeling.

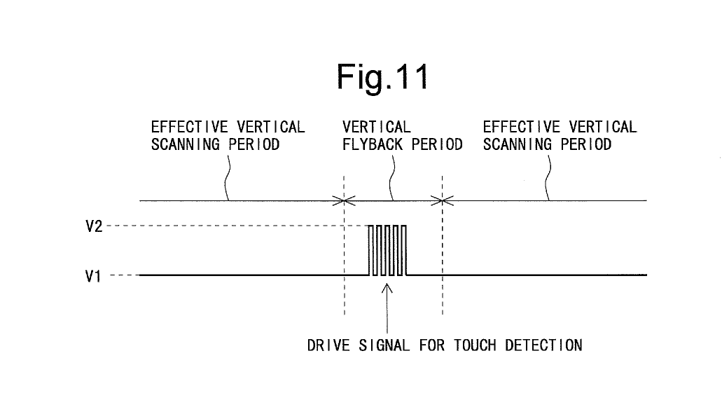

FIG. 11 is a waveform chart illustrating a variance in the voltage of the common electrode 13 during the display period. It should be noted that here, it is assumed that both of the drive frequency of the display operation and the drive frequency of the touch sensor are set to be 60 Hz. In this example, the touch sensor is driven every vertical scanning period. The touch sensor is driven during a vertical flyback period, for example. In this case, as illustrated in FIG. 11, in a part of the vertical flyback period, a voltage of the common electrode 13 varies between the common voltage V1 and the sensor voltage V2. Specifically, a drive signal for touch detection is supplied to the common electrode 13 during a part of the vertical flyback period. It should be noted that, during an effective vertical scanning period, the voltage of the common electrode 13 is maintained at the common voltage V1. In this manner, in the display period, touch detection is performed during the vertical flyback period.

It should be noted that, in a case where the drive frequency of the touch sensor is higher than the drive frequency of the display operation, the touch sensor may be driven during a part of the horizontal flyback period in addition to the vertical flyback period.

During the sleep period, the backlight 200 is maintained at the light-out state, and display operation is performed intermittently in the main body of the liquid crystal panel 100 (cf. FIG. 1). More specifically, in the main body of the liquid crystal panel 100, display operation for a specific image is performed every predetermined period. However, as the backlight 200 is in the light-out state, the specific image is not visible to the user. The touch sensor is driven at drive frequency of 30 Hz, for example. The drive frequency of the touch sensor is lower in the sleep period than in the display period, because detailed manipulation by touching is not required during the sleep period. As described above, in this embodiment, image data write processing is performed every predetermined period throughout the sleep period. It should be noted that in the following, a period in the sleep period, in which a specific image is displayed, is referred to as a “display insertion period”.

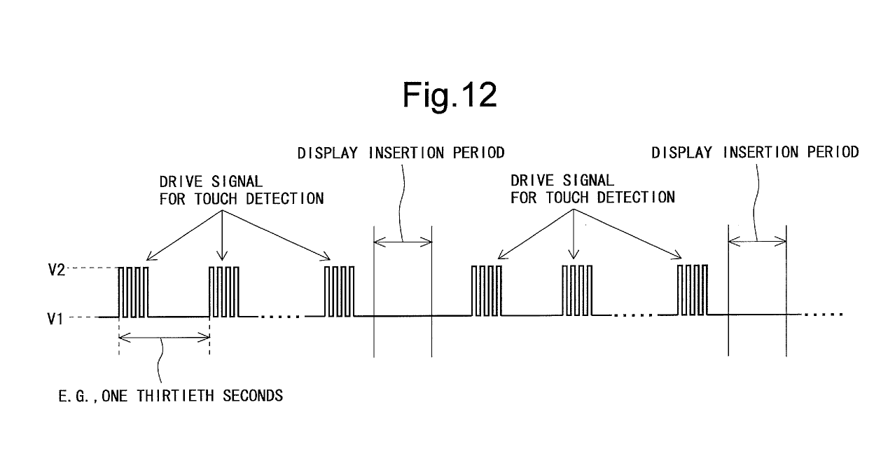

FIG. 12 is a waveform chart illustrating a variance in the voltage of the common electrode 13 during the sleep period. During the sleep period, as illustrated in FIG. 12, a drive signal for touch detection is supplied to the common electrode 13 every one thirtieth seconds, for example, excluding the display insertion period. With this, it is possible to detect a position on the liquid crystal panel 100 that has been touched also in the sleep period.

In the meantime, during a period excluding the display insertion period in the sleep period, the pixel electrode 12 is in a floating state. Therefore, an electric charge due to a drive signal for touch detection is accumulated within the liquid crystal panel 100. However, the display operation of the specific image is performed during the display insertion period. Specifically, a voltage corresponding to the specific image is applied to the pixel electrode 12 during the display insertion period. With this, an electric charge accumulated due to the drive signal for touch detection is discharged during the display insertion period.

It should be noted that in this embodiment, a display step is realized by an operation during the display period, a stopping step is realized by an operation during the sleep period, and an image data write insertion step is realized by an operation during the display insertion period in the sleep period.

### 1.5 Application Examples

The liquid crystal display device according to this embodiment may be applied to a wristwatch-type portable terminal device, for example. This example will be described below. During the display period, the wristwatch-type portable terminal device is in a state in which the device may be operated by the user. During the sleep period, the wristwatch-type portable terminal device is in a sleep state in which no image is displayed in the screen. Some wristwatch-type portable terminal devices of recent years has a function for resuming the device's state from the sleep state (sleeping state) to a normal state by taking a specific gesture (this function is referred to as a “wake-up gesture function”). By this function, the device's state is resumed from the sleep state to the normal state by moving an arm wearing the device upward, for example. In such a wristwatch-type portable terminal device, the device would do well to perform display operation of a specific image every predetermined period when the device is in the sleep state.

### 1.6 Effects

According to this embodiment, in the liquid crystal display device with a built-in touch sensor in which the common electrode 13 is used as an electrode for touch detection, display operation of a specific image is performed every predetermined period while the backlight 200 is maintained in the light-out state during the sleep period for stopping image display. Specifically, image data write processing is performed every predetermined period throughout the sleep period. Therefore, an electric charge accumulated within the liquid crystal panel 100 due to a drive signal for touch detection is discharged every predetermined period. With this, it is possible to reduce occurrence of flicker when switching from the sleep period to the display period is performed (when the backlight 200 is lit up).

Further, according to this embodiment, the drive frequency of the touch sensor is lower in the sleep period than in the display period. Therefore, accumulation of an electric charge within the liquid crystal panel 100 during the sleep period is suppressed. In this manner, the effect of reducing occurrence of flicker is improved.

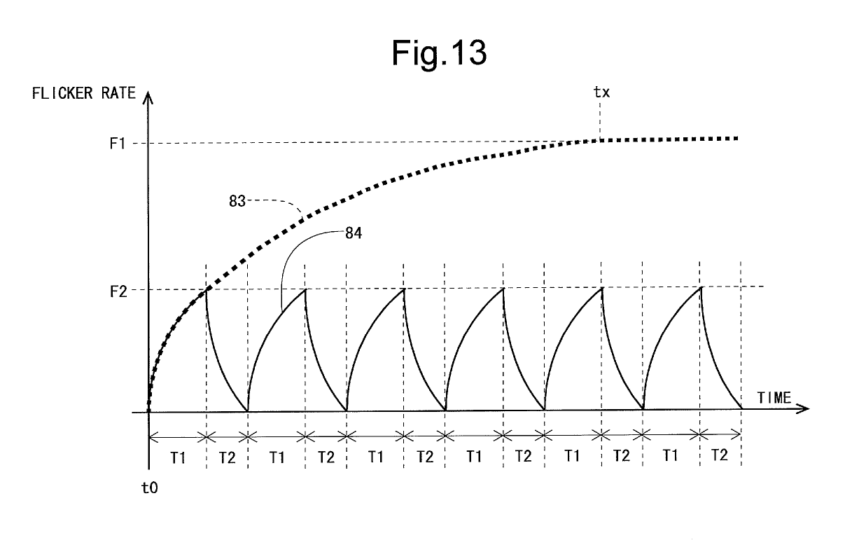

Here, with reference to FIG. 13, reduction of occurrence of flicker will be further described. FIG. 13 shows a comparison between a flicker rate in the conventional technique and a flicker rate in this embodiment. It should be noted that the flicker rate represents visibility of flicker. The higher the flicker rate is the more visible flicker is. In FIG. 13, the flicker rate in the conventional technique is indicated by a thick broken line 83, the flicker rate in this embodiment is indicated by a solid line 84, and a time point at which switching from the display period to the sleep period is performed is indicated by a reference number t0. Further, a period indicated by an arrow T1 corresponds to a no display period in the sleep period, and a period indicated by an arrow T2 corresponds to the display insertion period in the sleep period. According to the conventional technique, as the sleep period becomes longer, the flicker rate when switching from the sleep period to the display period is performed (when resuming from the sleep state to the normal state) increases. For example, at a time point indicated by a reference number tx, the flicker rate is F1. On the other hand, according to this embodiment, as described above, an electric charge accumulated within the liquid crystal panel 100 due to a drive signal for touch detection is discharged every predetermined period. Therefore, while the flicker rate increases during the no display period T1, the flicker rate decreases during the display insertion period. With this, even if the device resumes from the sleep state to the normal state at any timing, the flicker rate is no higher than F2 (F2<F1). As described above, according to this embodiment, the flicker rate is F2 at maximum, and the flicker rate becomes significantly lower than the case of the conventional technique.

As described above, according to this embodiment, in the liquid crystal display device with a built-in touch sensor using the common electrode 13 as an electrode for touch detection, the flicker rate when switching from the sleep period to the display period is performed (when resuming from the sleep state to the normal state) is reduced.

### 1.7 Modified Example

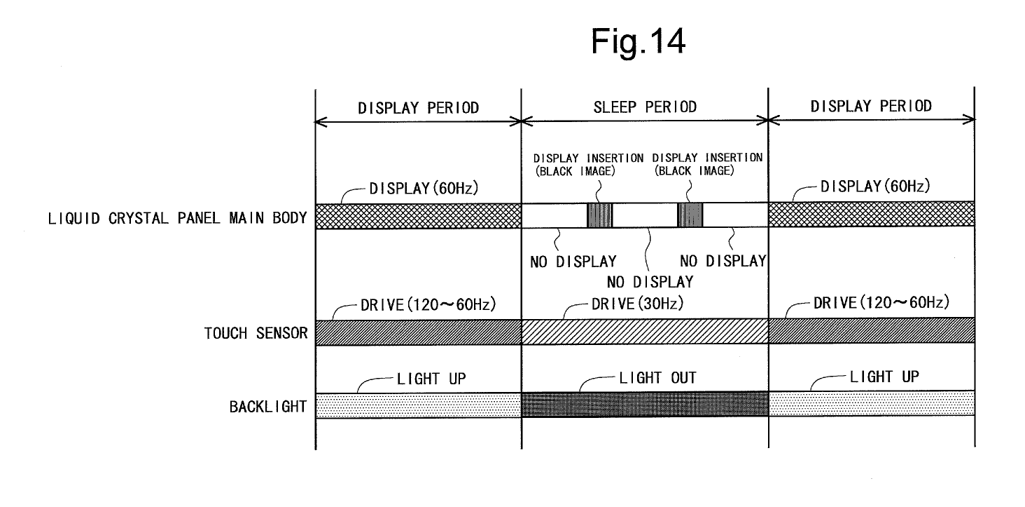

A modified example of the first embodiment will be described. FIG. 14 is a diagram for illustration of a drive method in this modified example. In the first embodiment, a specific image is inserted every predetermined period during the sleep period. On the other hand, in this modified example, a black image for displaying an entire screen in black is inserted every predetermined period. Regarding the other points, this modified example is the same as the first embodiment.

In a case of a reflective type liquid crystal display device and a semi-transmissive type liquid crystal display device, external light contributes to formation of an image.

Therefore, if the first embodiment is applied to such a reflective type liquid crystal display device or a semi-transmissive type liquid crystal display device, a specific image inserted during the display insertion period in the sleep period may become visible to the user. However, according to this modified example, an image inserted during the display insertion period is a black image. Therefore, it is possible to obtain an effect that an image inserted during the display insertion period in the sleep period does not become easily visible to the user, even if the device is a reflective type liquid crystal display device or a semi-transmissive type liquid crystal display device.

### 2. Second Embodiment

A liquid crystal display device according to the second embodiment of the present invention will be described. It should be noted that the points other than a drive method are the same as those in the first embodiment and therefore description thereof will be omitted.

### 2.1 Drive Method

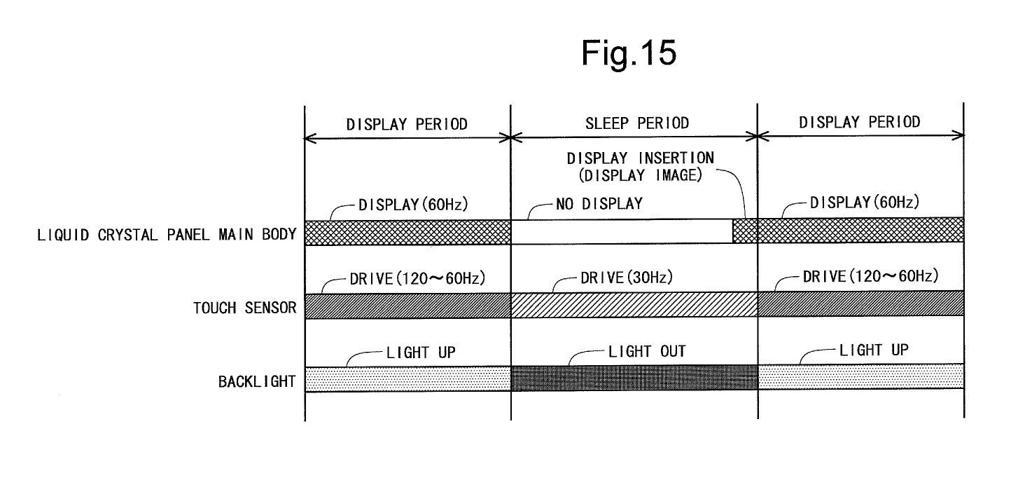

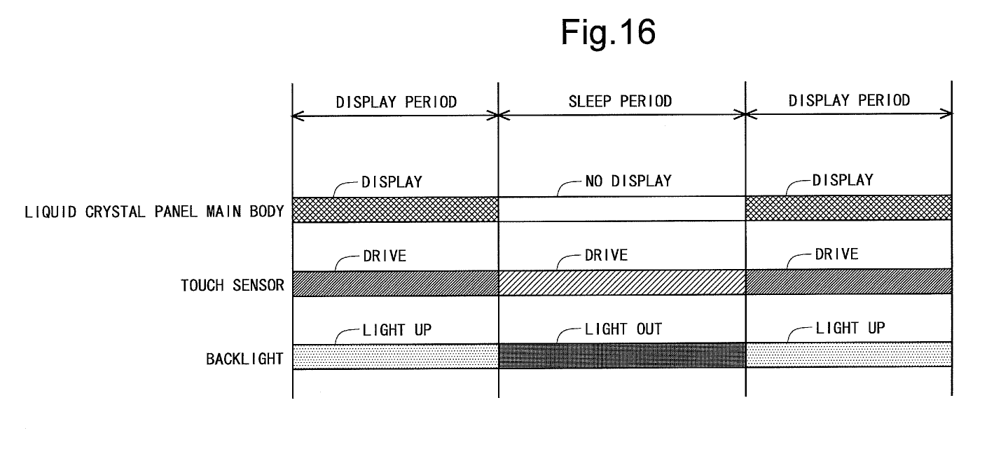

FIG. 15 is a diagram for illustration of a drive method in this embodiment. In the first embodiment, a specific image is inserted every predetermined period throughout the sleep period. On the other hand, in this embodiment, a display image (an image to be displayed in the display period) is inserted during a period immediately before switching to the display period is performed in the sleep period. Specifically, the display drive portion 112 performs image data write processing during the period immediately before switching to the display period is performed in the sleep period. Further, a voltage applied to the pixel electrode 12 in the image data write processing is a voltage corresponding to the image to be displayed in the display period.

According to this embodiment, at timing at which the user attempts to resume the device's state from the sleep state to the normal state, display operation is performed once while the backlight 200 is maintained in the light-out state, and then the backlight 200 is turned to the light-up state and intended display operation is performed.

It should be noted that an image displayed immediately before switching to the display period is performed may be a specific image such as a black image.

### 2.2 Effects

According to this embodiment, in the liquid crystal display device with a built-in touch sensor in which the common electrode 13 is used as an electrode for touch detection, immediately before switching from the sleep period for stopping image display to the display period for performing image display is performed, a voltage corresponding to an image to be displayed during the display period is applied to the pixel electrode 12 while the backlight 200 is maintained in the light-out state. Therefore, an electric charge accumulated within the liquid crystal panel 100 due to a drive signal for touch detection is discharged immediately before switching from the sleep period to the display period is performed. With this, it is possible to reduce occurrence of flicker when switching from the sleep period to the display period is performed (when the backlight 200 is lit up).

As described above, similarly to the first embodiment, in the liquid crystal display device with a built-in touch sensor using the common electrode 13 as an electrode for touch detection, it is possible to reduce occurrence of flicker when switching from the sleep period to the display period is performed (when resuming from the sleep state to the normal state) is reduced.

Further, according to this embodiment, image data write processing is performed in the sleep period only immediately before switching to the display period is performed. Therefore, it is possible to suppress an increase in power consumption due to display operation being performed during the sleep period.

### 3. Others

The present invention is not limited to the embodiments (including the modified example) described above, and may be modified in various manners without departing from the scope of the present invention. For example, while the self-capacitance method is employed as a method of position detection in the above embodiments, the present invention may also be applied to a case in which a mutual capacitance method is employed. Further, although the IPS mode is employed as the operational mode for the liquid crystals in the above embodiments, the present invention may also be applied to a case in which a mode other than IPS mode is employed.

This application claims priority to Japanese Patent Application No. 2016-042964 filed on Mar. 7, 2016 under the title of “LIQUID CRYSTAL DISPLAY DEVICE WITH BUILT-IN TOUCH SENSOR, AND DRIVE METHOD THEREFOR”, the contents of which are incorporated herein by reference.

### DESCRIPTION OF REFERENCE CHARACTERS

11: TFT
12: PIXEL ELECTRODE
13: COMMON ELECTRODE
14: LIQUID CRYSTAL CAPACITANCE
100: LIQUID CRYSTAL PANEL
101: DISPLAY PORTION
111: OVERALL CONTROL PORTION
112: DISPLAY DRIVE PORTION
113: SENSOR DRIVE PORTION
131: COMMON ELECTRODE WIRING
132: CONTACT PORTION
200: BACKLIGHT
300: BACKLIGHT CONTROL PORTION

1. A liquid crystal display device with a built-in touch sensor, the liquid crystal display device having a display period for performing image display and a sleep period for stopping image display, the liquid crystal display device comprising:
a liquid crystal panel including a pixel electrode and a common electrode;
a backlight configured to irradiate the liquid crystal panel with light;
a display drive portion configured to perform image data write processing during the display period, the image data write processing being a process in which a desired voltage is applied to the pixel electrode in a state in which a constant voltage is applied to the common electrode;
a backlight control portion configured to maintain the backlight in a light-up state during the display period, and maintain the backlight in a light-out state during the sleep period; and
a sensor drive portion configured to perform position detection processing during both of the display period and the sleep period, the position detection processing being a process in which a position on the liquid crystal panel that has been touched is detected,
wherein
the common electrode is used as an electrode for the position detection processing, and
the display drive portion also performs the image data write processing at least during a part of the sleep period.

2. The liquid crystal display device according to claim 1, wherein
the display drive portion performs the image data write processing every predetermined period throughout the sleep period.

3. The liquid crystal display device according to claim 2, wherein
a voltage applied to the pixel electrode in the image data write processing during the sleep period is a voltage corresponding to a specific image.

4. The liquid crystal display device according to claim 3, wherein
the specific image is an image for displaying an entire screen of the liquid crystal panel in black.

5. The liquid crystal display device according to claim 1, wherein
the display drive portion performs the image data write processing during a period immediately before switching to the display period is performed in the sleep period.

6. The liquid crystal display device according to claim 5, wherein
a voltage applied to the pixel electrode in the image data write processing during the sleep period is a voltage corresponding to an image to be displayed in the display period.

7. The liquid crystal display device according to claim 1, wherein
the sensor drive portion performs the position detection processing less frequently in the sleep period than in the display period.

8. A drive method for a liquid crystal display device with a built-in touch sensor, the liquid crystal display device having a display period for performing image display and a sleep period for stopping image display, wherein
the liquid crystal display device includes:
a liquid crystal panel including a pixel electrode and a common electrode;
a backlight configured to irradiate the liquid crystal panel with light;
a display drive portion configured to perform image data write processing in which a desired voltage is applied to the pixel electrode in a state in which a constant voltage is applied to the common electrode;
a backlight control portion configured to control a state of the backlight; and
a sensor drive portion configured to perform position detection processing during both of the display period and the sleep period, the position detection processing being a process in which a position on the liquid crystal panel that has been touched is detected,
the common electrode is used as an electrode for the position detection processing, and
the drive method comprises:
a display step in which, during the display period, the backlight control portion maintains the backlight in a light-up state and the display drive portion performs the image data write processing so that a voltage depending on a target display image is applied to the pixel electrode;
a stopping step in which the backlight control portion maintains the backlight in a light-out state during the sleep period; and
an image data write insertion step in which the display drive portion performs the image data write processing at least during a part of the sleep period.
